(19) United States
(12) Patent Application Publication
(10) Pub. No.: US 2026/0163698 A1
(43) Pub. Date: Jun. 11, 2026

(54) METHOD AND APPARATUS FOR DETERMINING CHANNEL STATE INFORMATION (CSI)

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 19/126,874

(22) PCT Filed: Nov. 4, 2022
(86) PCT No.: PCT/CN2022/130141

§ 371 Date: May 2, 2025

(51) Int. Cl. H04L 5/00

(52) U.S. Cl. CPC H04L 5/0051

(57) ABSTRACT

A method determining channel state information (CSI), and an apparatus thereof, which method and apparatus can be applied to the technical field of communications. The method, which is executed by means of a terminal device, comprises: according to a first parameter, determining a bit width occupied by first information in CSI, wherein the first information is used for indicating the number of SD basis vectors corresponding to one or more channel state information reference signal (CSI-RS) resources selected by a terminal device. It is thus ensured that the network device can accurately calculate precoding for downlink data transmission.

### CROSS-REFERENCE TO RELATED APPLICATIONS

This application is a national stage of International Application No. PCT/CN2022/130141, filed on Nov. 4, 2022, which is hereby incorporated by reference in its entirety.

### TECHNICAL FIELD

The present disclosure relates to the field of communication technology, and in particular, to a method and apparatus for determining channel state information (CSI).

### BACKGROUND

Generally, in a scenario with multiple transmission and reception points (TRPs), a network device may directly configure, for a terminal device, a number of space domain (SD) basis vectors corresponding to each channel state information reference signal (CSI-RS) resource. In such case, when determining channel state information (CSI), the terminal device does not need to indicate or report the number of SD basis vectors corresponding to each CSI-RS resource. However, if the network device configures only a sum of a number of the SD basis vectors corresponding to the CSI-RS resources, or configures a maximum value of the sum of a number of the SD basis vectors corresponding to the CSI-RS resources, the terminal device needs to indicate a number of selected SD basis vectors corresponding to each CSI-RS resource when reporting the CSI, hence how to indicate the number of selected SD basis vectors corresponding to each CSI-RS resource is an urgent problem to be addressed.

### SUMMARY

Embodiments of the present disclosure provide a method and apparatus for determining channel state information (CSI).

In a first aspect, an embodiment of the present disclosure provides a method for determining channel state information (CSI), performed by a terminal device, including: determining, according to a first parameter, a bit width occupied by first information in the CSI, where the first information indicates a number of space domain (SD) basis vectors selected by the terminal device corresponding to one or more channel state information-reference signal (CSI-RS) resources.

In the present disclosure, the terminal device determines the bit width occupied by the first information by using the same first parameter as a network device. In such way, it is ensured that the terminal device and the network device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

In a second aspect, an embodiment of the present disclosure provides another method for determining channel state information (CSI), performed by a network device, including: determining, according to a first parameter, a bit width occupied by first information in the CSI sent by a terminal device, where the first information indicates a number of space domain (SD) basis vectors selected by the terminal device corresponding to one or more channel state information-reference signal (CSI-RS) resources.

In the present disclosure, the network device determines the bit width occupied by the first information by using the same first parameter as the terminal device. In such way, it is ensured that the terminal device and the network device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

In a third aspect, an embodiment of the present disclosure provides a communication apparatus, including: a processing module, configured to determine, according to a first parameter, a bit width occupied by first information in channel state information (CSI), where the first information indicates a number of space domain (SD) basis vectors corresponding to one or more channel state information-reference signal (CSI-RS) resources selected by a terminal device.

In a fourth aspect, an embodiment of the present disclosure provides a communication apparatus, including: a processing module, configured to determine, according to a first parameter, a bit width occupied by first information in channel state information (CSI) sent by a terminal device, where the first information indicates a number of space domain (SD) basis vectors selected by the terminal device corresponding to one or more channel state information-reference signal (CSI-RS) resources.

In a fifth aspect, an embodiment of the present disclosure provides a communication device, including: a processor, and when the processor executes a computer program in a memory, the method according to the first aspect is implemented.

In a sixth aspect, an embodiment of the present disclosure provides a communication device, including: a processor, and when the processor executes a computer program in a memory, the method according to the second aspect is implemented.

In a seventh aspect, an embodiment of the present disclosure provides a communication device, including a processor and a memory, where the memory stores a computer program; the processor is configured to executes the computer program stored in the memory, to cause the communication device to perform the method according to the first aspect.

In an eighth aspect, an embodiment of the present disclosure provides a communication device, including a processor and a memory, where the memory stores a computer program; the processor is configured to executes the computer program stored in the memory, to cause the communication device to perform the method according to the second aspect.

In a ninth aspect, an embodiment of the present disclosure provides a communication device, including a processor and an interface circuit, where the interface circuit is configured to receive a code instruction and transmit the code instruction to the processor, and the processor is configured to execute the code instruction, to cause the device to perform the method according to the first aspect.

In a tenth aspect, an embodiment of the present disclosure provides a communication device, including a processor and an interface circuit, where the interface circuit is configured to receive a code instruction and transmit the code instruction to the processor, and the processor is configured to execute the code instruction, to cause the device to perform the method according to the second aspect.

In an eleventh aspect, an embodiment of the present disclosure provides a communication system, where the system includes the communication apparatus according to the third aspect and the communication apparatus according to the fourth aspect; or the system includes the communication device according to the fifth aspect and the communication device according to the sixth aspect; or the system includes the communication device according to the seventh aspect and the communication device according to the eighth aspect; or the system includes the communication device according to the ninth aspect and the communication device according to the tenth aspect.

In a twelfth aspect, an embodiment of the present disclosure provides a computer-readable storage medium, configured to store an instruction used by the terminal device, and when the instruction is executed, the terminal device is caused to perform the method according to the first aspect.

In a thirteenth aspect, an embodiment of the present disclosure provides a readable storage medium, configured to store an instruction used by the network device, and when the instruction is executed, the network device is caused to perform the method according to the second aspect.

In a fourteenth aspect, the present disclosure provides a computer program product, including a computer program, where when the computer program is running on a computer, the computer is caused to perform the method according to the first aspect.

In a fifteenth aspect, the present disclosure provides a computer program product, including a computer program, where when the computer program is running on a computer, the computer is caused to perform the method according to the second aspect.

In a sixteenth aspect, the present disclosure provides a chip system, including at least one processor and an interface, where the chip system is configured to support the terminal device to implement functions in the first aspect or the second aspect, for example, functions of determining or processing at least one of data and information in the method. In a possible design, the chip system further includes a memory, and the memory is configured to store a computer program and data that are necessary for the terminal device. The chip system may include a chip, or may include the chip and another separate device.

According to a seventeenth aspect, the present disclosure provides a computer program, where when the computer program is running on a computer, the computer is caused to perform the method according to the first aspect or perform the method according to the second aspect.

### BRIEF DESCRIPTION OF DRAWINGS

In order to more clearly describe the technical solutions in the embodiments or the background of the present disclosure, the accompanying drawings required in the embodiments or the background of the present disclosure will be described below.

FIG. 1 is a schematic architectural diagram of a communication system according to an embodiment of the present disclosure.

FIG. 2 is a schematic flowchart of a method for determining channel state information according to an embodiment of the present disclosure.

FIG. 3 is a schematic flowchart of another method for determining channel state information according to an embodiment of the present disclosure.

FIG. 4 is a schematic flowchart of another method for determining channel state information according to an embodiment of the present disclosure.

FIG. 5 is a schematic flowchart of another method for determining channel state information according to an embodiment of the present disclosure.

FIG. 6 is a schematic flowchart of another method for determining channel state information according to an embodiment of the present disclosure.

FIG. 7 is a schematic flowchart of another method for determining channel state information according to an embodiment of the present disclosure.

FIG. 8 is a schematic flowchart of another method for determining channel state information according to an embodiment of the present disclosure.

FIG. 9 is a schematic flowchart of another method for determining channel state information according to an embodiment of the present disclosure.

FIG. 10 is a schematic structural diagram of a communication apparatus according to an embodiment of the present disclosure.

FIG. 11 is a schematic structural diagram of another communication apparatus according to an embodiment of the present disclosure.

FIG. 12 is a schematic structural diagram of a chip according to an embodiment of the present disclosure.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the present disclosure. Rather, they are merely examples of apparatuses and methods consistent with some aspects of the present disclosure as detailed in the appended claims.

To facilitate understanding, terms used in the present disclosure are first described.

### 1. Transmission and Reception Point (TRP)

A TRP is equivalent to a conventional base station, but in some cases, one cell may be covered by more than one TRP, but by multiple TRPs jointly.

### 2. Channel State Information-Reference Signal (CSI-RS)

A main function of the CSI-RS is for measurement of downlink signal information. It is a known signal provided by the transmitting end to the receiving end for channel estimation or channel sounding. The CSI-RS may be used for channel state information measurement, beam management, time-frequency tracking, mobility management of the terminal device. One CSI-RS resource corresponds to one TRP or one TRP group.

### 3. Space Domain Basis Vector (SD Basis)

SD basis, also referred to as a beam base vector or beam, indicates a beam selected by the terminal device, for example, L beams are selected from N1*N2 ports.

Referring to FIG. 1, FIG. 1 is a schematic architectural diagram of a communication system according to an embodiment of the present disclosure. The communication system may include but is not limited to one network device (e.g., TRP) and one terminal device, and a number and form of devices shown in FIG. 1 are merely examples, and do not constitute a limitation on the embodiments of the present disclosure. In practice, there may be two or more network devices, and two or more terminal devices. The communication system shown in FIG. 1 may include, for example, one network device 11 and one terminal device 12.

It should be noted that the technical solutions of the embodiments of the present disclosure may be applied to various communication systems. For example, a long term evolution (LTE) system, a 5th generation (5G) mobile communication system, a 5G new radio (NR) system, or another future new mobile communication system.

The network device 11 in the embodiments of the present disclosure includes an evolved NodeB (eNB), a transmission reception point (TRP), a next generation NodeB (gNB) in an NR system, a base station in another future mobile communication system, an access node in a wireless fidelity (WiFi) system, or the like. Specific technologies and specific device forms used by the network device are not limited in the embodiments of the present disclosure. The network device provided in the embodiments of the present disclosure may include a central unit (CU) and a distributed unit (DU), where the CU may also be referred to as a control unit, by adopting a CU-DU structure, protocol layers of the network device (for example, a base station) may be separated, functions of some protocol layers are centrally controlled by the CU, and functions of some or all of the remaining protocol layers are distributed in the DU, and the DU is centrally controlled by the CU.

The terminal device 12 in the embodiments of the present disclosure is a user-side entity used to receive or transmit a signal, for example, a mobile phone. The terminal device may also be referred to as a terminal, user equipment (UE), a mobile station (MS), a mobile terminal (MT), or the like. The terminal device may be an automobile with a communication function, a smart automobile, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, or the like. Specific technologies and specific device forms used by the terminal device are not limited in the embodiments of the present disclosure.

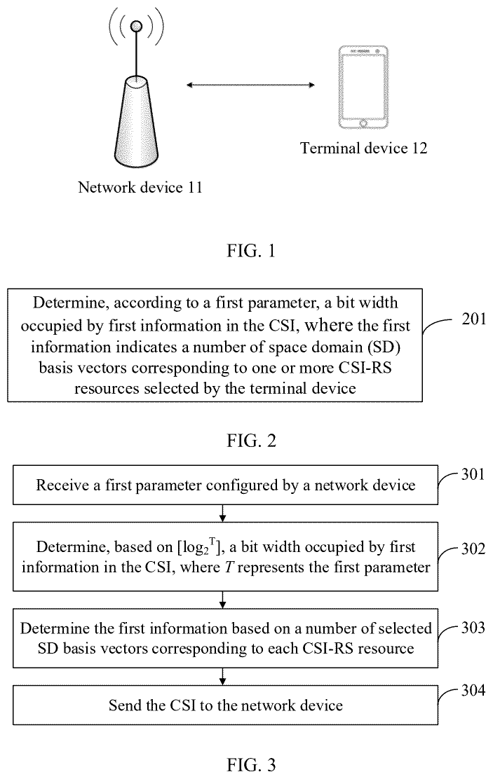

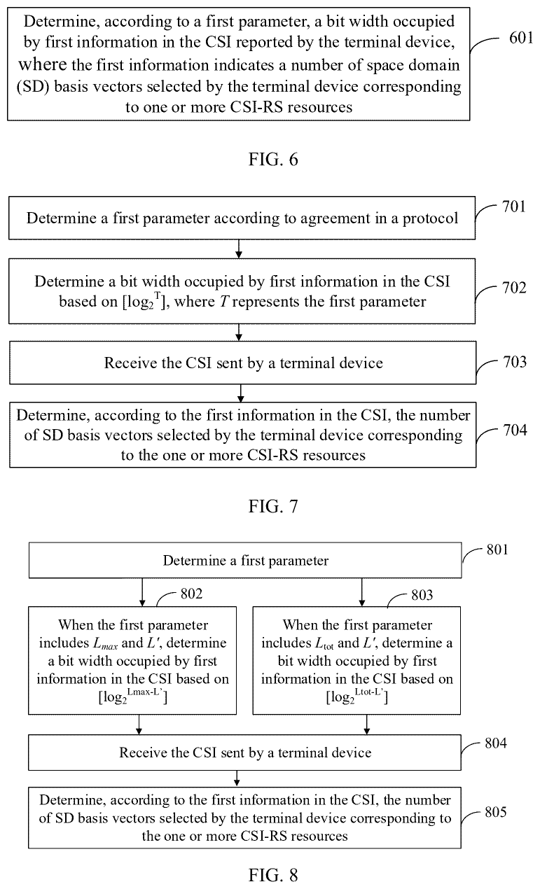

In this communication system, the terminal device may perform the embodiment described in any embodiment in FIG. 2 to FIG. 5, and the network device may perform the embodiment described in any embodiment in FIG. 6 to FIG. 9.

It may be understood that the communication system described in the embodiments of the present disclosure is intended to describe the technical solutions of the embodiments of the present disclosure more clearly, and does not constitute a limitation on the technical solutions provided in the embodiments of the present disclosure. Those skilled in the art may know that with the evolution of system architecture and the emergence of new business scenarios, the technical solutions provided by the embodiments of the present disclosure are also applicable to similar technical problems.

It should be noted that, in the present disclosure, the method for determining channel state information (CSI) provided in any embodiment may be performed separately, or may be performed together with a possible implementation method in another embodiment, or may be performed together with any technical solution in related technologies.

Embodiments of the present disclosure will be further described with reference to the accompanying drawings and specific embodiments.

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of the present disclosure as detailed in the appended claims.

The terminology used in the embodiments of the present disclosure is for the purpose of describing particular embodiments only and is not intended to limit the embodiments of the present disclosure. The singular forms “a/an”, “the”, and “said” used in the embodiments of the present disclosure and the appended claims are also intended to include plural forms unless the context clearly indicates other meanings. It should also be understood that the term “and/or” as used herein refers to and includes any or all possible combinations of one or more associated listed item.

Embodiments of the present disclosure are described in detail below, examples of which are shown in the accompanying drawings, where the same or similar reference numerals denote the same or similar elements throughout. The embodiments described below with reference to the accompanying drawings are examples and are intended to explain the present disclosure, and cannot be construed as limiting the present disclosure.

When multiple TRPs perform coherent joint transmission (CJT), a codebook structure used for transmission between the terminal device and the network device is related to the number of SD basis vectors corresponding to each channel state information-reference signal (CSI-RS) resource (that is, each TRP or each TRP group) selected by the terminal device, which requires that the terminal device and the network device comprehend the number of SD basis vectors corresponding to each CSI-RS resource selected by the terminal device in a same way, otherwise, performance based on multi-TRP coherent joint transmission may be affected. When the network device does not configure the number of SD basis vectors corresponding to each CSI-RS resource (that is, the TRP or the TRP group) for the terminal device, the terminal device may report, after measuring and selecting the number of SD basis vectors corresponding to each CSI-RS resource, the determined number of SD basis vectors corresponding to one or more CSI-RS resources to the network device by using the first information in the CSI.

However, when the CJT includes a plurality of TRPs, the network device needs to accurately determine, based on the first information, the SD basis vectors corresponding to each CSI-RS resource selected by the terminal device. In other words, the network device and the terminal device need to keep consistent comprehension of the first information. For example, how much bit width does the first information occupy in CSI, which part of the bit width corresponds to which CSI-RS resource, and so on. According to the CSI reporting method provided by the present disclosure, the comprehension of the first information by the network equipment and the terminal equipment can be kept consistent, so that the network device can accurately determine the number of SD basis vectors corresponding to each CSI-RS resource selected by the terminal equipment, thus the network device can accurately calculate the precoding used for downlink data transmission, by which the transmission performance of multi-TRP based coherent joint transmission is improved.

Referring to FIG. 2, FIG. 2 is a schematic flowchart of a method for determining channel state information (CSI) according to an embodiment of the present disclosure, where the method is performed by the terminal device. As shown in FIG. 2, the method may include but is not limited to a following step.

Step 201, determining, according to a first parameter, a bit width occupied by first information in the CSI, where the first information indicates a number of space domain (SD) basis vectors corresponding to one or more CSI-RS resources selected by the terminal device.

In the present disclosure, as the first information indicates, to the network device, the number of SD basis vectors corresponding to one or more CSI-RS resources selected by the terminal device, that is, the first information may include a number of SD basis vectors corresponding to one CSI-RS resource, or may include a number of SD basis vectors corresponding to a plurality of CSI-RS resources. To ensure that the terminal device and the network device have same comprehension of the first information, it needs to be ensured that the network device and the terminal device have same comprehension of the bit width occupied by the first information. In the present disclosure, the terminal device may determine the bit width occupied by the first information in a same way as the network device does.

Optionally, the first parameter may be determined by the terminal device based on agreement in a protocol, or may be sent by the network device to the terminal device.

Optionally, the network device may configure the first parameter for the terminal device by using high-layer signaling, for example, the network device may configure the first parameter for the terminal device by using one or more of a radio resource control (RRC) message, a medium access control control element (MAC-CE), or downlink control information (DCI) signaling.

In other words, the network device may determine the bit width occupied by the first information in the CSI based on the first parameter as the terminal device does, thereby ensuring that the terminal device and the network device understand the first information in a same way, so that the network device can accurately determine the number of SD basis vectors corresponding to each CSI-RS resource selected by the terminal device, thereby ensuring that the network device can accurately calculate the precoding used for downlink data transmission.

Optionally, the first parameter may include at least one of: a maximum selectable number L of SD basis vectors corresponding to each of the CSI-RS resources; a maximum value Lₘₐₓ of a sum of a number of SD basis vectors selectable by the terminal device corresponding to all CSI-RS resources; a sum Lₜₒₜ of a number of SD basis vectors selectable by the terminal device corresponding to all CSI-RS resources; a maximum number X of first combinations, where a value of an i-th element in each of the first combinations represents a number of SD basis vectors corresponding to an i-th CSI-RS resource selected by the terminal device from all CSI-RS resources, where i is a natural number; a maximum number Y of second combinations, where a value of a j-th element in each of the second combinations represents a number of SD basis vectors selected by the terminal device corresponding to a j-th CSI-RS resource in CSI-RS resources other than a first CSI-RS resource, where j is a natural number; a number L′ of SD basis vectors corresponding to the first CSI-RS resource; a sum Lₜₒₜ′ of a number of SD basis vectors selectable by the terminal device corresponding to CSI-RS resources other than the first CSI-RS resource; or a maximum value Lₘₐₓ′ of the sum of a number of SD basis vectors selectable by the terminal device corresponding to CSI-RS resources other than the first CSI-RS resource.

L refers to that when the terminal device is selecting SD basis vectors corresponding to each CSI-RS resource, a maximum number of the SD basis vectors must not exceed L. For example, if Lₙ=5, when the terminal device is selecting the SD basis vectors corresponding to an n-th CSI-RS resource, the terminal device may select 0, 1, 2, 3, 4, or 5 SD basis vectors.

In addition, Lₘₐₓ refers to that a sum of a number of all SD basis vectors selected by the terminal device cannot exceed a maximum number Lₘₐₓ. For example, if Lₘₐₓ=10, when the terminal device is configured to use 3 TRPs for CJT transmission, a sum of a number of selected basis vectors Lₙ corresponding to the CSI-RS resources is less than or equal to 10, that is, L₁+L₂+L₃≤10.

In addition, Lₜₒₜ refers to a sum of a number of all SD basis vectors that need to be selected by the terminal device. For example, if Lₜₒₜ=7, when the terminal device is configured to use 3 TRPs for CJT transmission, a sum of numbers Lₙ of selected basis vectors corresponding to CSI-RS resources is equal to 7, that is, L₁+L₂+L₃=7.

The first combinations refer to combinations of numbers of SD basis vectors selected by the terminal device from SD basis vectors corresponding to all CSI-RS resources. For example, if 3 CSI-RS resources are configured for the terminal device, and a maximum number of SD basis vectors corresponding to each CSI-RS is 4, a set of candidate numbers of SD basis vectors corresponding to each CSI-RS resource is {0, 1, 2, 3, 4}. Thus, a maximum number of the first combinations is X=5*5*5=125. For example, a first combination being {0, 0, 0} indicates that a number of SD basis vectors corresponding to each CSI-RS resource selected by the terminal device is 0; and a first combination being {0, 0, 1}, indicates that a number of SD basis vectors corresponding to first and second CSI-RS resources selected by the terminal device is 0, and a number of SD basis vectors corresponding to a third CSI-RS resource is 1.

The second combinations are combinations of numbers of SD basis vectors selected by the terminal device from SD basis vectors corresponding to CSI-RS resources other than the first CSI-RS resource. For example, if the terminal device is configured with 3 CSI-RS resources, and a maximum number of SD basis vectors corresponding to two CSI-RS resources other than the first CSI-RS resource is 4, a set of candidate numbers of SD basis vectors corresponding to each of the two CSI-RS resources is {0, 1, 2, 3, 4}. Thus, a maximum number of second combinations is Y=5*5=25. For example, a second combination being {0, 1} indicates that a number of SD basis vectors corresponding to a first one of CSI-RS resources other than the first CSI-RS resource selected by the terminal device is 0, and a number of SD basis vectors corresponding to a second one of CSI-RS resources is 1.

Lₜₒₜ′ refers to a sum of a number of SD basis vectors corresponding to other CSI-RS resources except the first CSI-RS resource that the terminal device needs to select. For example, if Lₜₒₜ′=5, when the terminal device is configured to use 3 TRPs for CJT transmission, a sum of a number of basis vectors corresponding to two CSI-RS resources other than the first CSI-RS resource that need to be selected is 5.

Lₘₐₓ′ refers to that a sum of a number of all SD basis vectors corresponding to other CSI-RS resources except the first CSI-RS resource selected by the terminal device cannot exceed a maximum number Lₘₐₓ′. For example, if Lₘₐₓ=7, when the terminal device is configured to use 3 TRPs for CJT transmission, a sum of a number of basis vectors corresponding to CSI-RS resources other than the first CSI-RS resource selected by the terminal device should be less than or equal to 7. Optionally, the number of SD basis vectors selected by the terminal device corresponding to the one or more CSI-RS resources may be indicated by using content of the first information, for example, a value of each bit in the first information.

For example, the terminal device is configured to perform CJT based on 3 TRPs, and it is determined, based on the first parameter, that a bit width occupied by the first information is 9, that is, a number of SD basis vectors corresponding to each CSI-RS resource occupies 3 bits. In this case, the terminal device may first calculate a receive power of each candidate SD basis vector based on estimated and measured downlink channel information from each TRP to the terminal device and candidate SD basis vectors, and after sorting the receive powers, the terminal device may determine that a number of SD basis vectors corresponding to each CSI-RS resource is Lₙ, for example, L₁=3, L₂=2, and L₃=1. Further, the terminal device may further determine a combination coefficient in a codebook structure based on the selected SD basis vectors corresponding to each CSI-RS resource, and then further determine a number of SD basis vectors corresponding to each CSI-RS resource, for example, L₁=2, L₂=2 and L₃=1. In this case, it may be determined that a value of each bit in the first information is 010010001.

After determining the content of the first information in the CSI, the terminal device may send the CSI to the network device, so that the network device parses the first information based on the same understanding as the terminal device on the bit width occupied by the first information, to determine the SD basis vectors selected by the terminal device corresponding to the one or more CSI-RS resources.

It should be noted that after the terminal device determines, based on the first parameter, the bit width occupied by the first information, if the first parameter does not change during CSI reporting, the terminal device may keep understanding of the bit width occupied by the first information unchanged. In other words, each time the number of selected SD basis vectors corresponding to the CSI-RS resources changes, the content of the first information may be updated based on the understanding of the bit width occupied by the same first information.

For example, after the terminal device reports the CSI with the first information being 010010001 for the first time, and when the terminal device performs SD basis vector selection again when the first parameter remains unchanged, the number of selected SD basis vectors corresponding to the CSI-RS resources is, for example, L₁=1, L₂=3 and L₃=1, the first information in the reported CSI is: 001011001.

If the first parameter is updated when the terminal device reports the CSI, before reporting the CSI, the terminal device first needs to re-determine, based on the updated first parameter, the bit width occupied by the first information.

For example, if the first parameter is updated when the terminal device is to report the CSI again after the terminal device reported the CSI with the first information being 010010001 for the first time, it is determined, based on the updated first parameter, that the bit width occupied by the first information is 6, and when SD basis vector selection is performed again, a number of selected SD basis vectors corresponding to each CSI-RS resource is, for example, L₁=1, L₂=3 and L₃=1, in such case, the first information in the reported CSI is 011101.

In some possible embodiments, the first information may be included in a first part (part1) of the reported CSI.

In the present disclosure, the terminal device may determine the bit width occupied by the first information in the CSI based on the first parameter in the same way as the network device does. In such way, it is ensured that the terminal device and the network device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

Referring to FIG. 3, FIG. 3 is a schematic flowchart of another method for determining channel state information (CSI) according to an embodiment of the present disclosure. The method is performed by a terminal device. As shown in FIG. 3, the method may include but is not limited to following steps.

Step 301, receiving a first parameter configured by a network device.

The first parameter includes any one of: a maximum selectable number L of SD basis vectors corresponding to each of the CSI-RS resources; a maximum value Lₘₐₓ of a sum of a number of SD basis vectors selectable by the terminal device corresponding to all CSI-RS resources; a sum Lₜₒₜ of a number of SD basis vectors selectable by the terminal device corresponding to all CSI-RS resources; a maximum number X of first combinations, where a value of an i-th element in each of the first combinations represents a number of SD basis vectors selected by the terminal device corresponding to an i-th CSI-RS resource in all CSI-RS resources, where i is a natural number; a maximum number Y of second combinations, where a value of a j-th element in each of the second combinations represents a number of SD basis vectors selected by the terminal device corresponding to a j-th CSI-RS resource in CSI-RS resources other than a first CSI-RS resource, where j is a natural number; a sum Lₜₒₜ′ of a number of SD basis vectors selectable by the terminal device corresponding to CSI-RS resources other than the first CSI-RS resource; or a maximum value Lₘₐₓ′ of the sum of a number of SD basis vectors selectable by the terminal device corresponding to CSI-RS resources other than the first CSI-RS resource.

The meaning of the “first parameter” can be referred from the detailed description of any embodiment of the present disclosure, which will not be repeated herein.

Optionally, the network device may configure the first parameter for the terminal device by using high-layer signaling, for example, the network device may configure the first parameter for the terminal device by using one or more of a radio resource control (RRC) message, a medium access control control element (MAC-CE), or downlink control information (DCI) signaling.

Step 302, determining, based on

$$⌈ {log}_{2}^{T} ⌉ ,$$

a bit width occupied by first information in the CSI, where T represents the first parameter.

For example, if the terminal device is configured to perform CJT transmission by using 3 TRPs, the first parameter is L, and a value of L is 5, that is, when selecting and reporting the SD basis vectors corresponding to each CIS-RS resource, a number thereof does not exceed 5, it may be determined that a maximum bit width occupied by the number of SD basis vectors corresponding to each CSI-RS resource is:

$$⌈ {log}_{2}^{5} ⌉ = 3 ,$$

further N_{TRP}=3, so that it may be determined that the bit width occupied by the first information is: 3*3=9 bits.

Optionally, if N_{TRP}=3, the first parameter is Lₘₐₓ, and a value of Lₘₐₓ is 8, that is, when selecting and reporting the SD basis vectors corresponding to each CIS-RS resource, a number thereof does not exceed 8, it may be determined that a maximum bit width occupied by a number of SD basis vectors corresponding to each CSI-RS resource is

$$⌈ {log}_{2}^{{L}_{max}} ⌉ = 3 ,$$

and further N_{TRP}=3, so that it may be determined that a bit width occupied by the first information is 3*3=9 bits.

Optionally, if N_{TRP}=3, the first parameter is Lₜₒₜ, and a value of Lₜₒₜ is 6, that is, when selecting and reporting the SD basis vectors corresponding to each CIS-RS resource, a number thereof does not exceed 6, it may be determined that the maximum bit width occupied by the number of SD basis vectors corresponding to each CSI-RS resource is

$$⌈ {log}_{2}^{{L}_{tot}} ⌉ = 3 ,$$

and further N_{TRP}=3, so that it may be determined that the bit width occupied by the first information is 3*3=9 bits.

In other words, the terminal device may first determine, based on the first parameter, the maximum bit width occupied by the number of SD basis vectors corresponding to each CSI-RS resource, and then determine the bit width occupied by the first information based on the maximum number of coordinated TRPs (NTPR) corresponding to the terminal device and the maximum bit width occupied by the SD basis vectors corresponding to each CSI-RS resource.

Optionally, if the first parameter is X and X=125, it may be determined that the bit width occupied by the first information field is:

$$⌈ {log}_{2}^{X} ⌉ = 7 .$$

In addition, it should be noted that if the first parameter is the number of SD basis vectors corresponding to the CSI-RS resources other than the first CSI-RS resource, it may be considered that the number of SD basis vectors corresponding to the first CSI-RS resource is known. For example, the network device may configure, for the terminal device, the number of SD basis vectors corresponding to the first CSI-RS resource, or the terminal device may determine, based on agreement in a protocol, the number of SD basis vectors corresponding to the first CSI-RS resource.

In other words, in this case, the terminal device only needs to report, to the network device, the number of SD basis vectors corresponding to the CSI-RS resources other than the first CSI-RS resource. Correspondingly, the bit width occupied by the first information may be determined only based on the first parameter (for example, Lₘₐₓ′ [symbol] Lₜₒₜ, or Y) used to represent the number of SD basis vectors corresponding to the CSI-RS resources other than the first CSI-RS resource.

For example, if N_{TRP}=3, the first parameter is Lₘₐₓ′, and a value of Lₘₐₓ′ is 6, it may be determined that a maximum bit width occupied by a number of SD basis vectors corresponding to CSI-RS resources other than the first CSI-RS resource is

$$⌈ {log}_{2}^{{L}_{max}^{′}} ⌉ = 3 ,$$

and further because N_{TRP}=3, it may be determined that a bit width occupied by the first information is 2*3=6 bits.

Optionally, if N_{TRP}=3, the first parameter is Lₜₒₜ′, and a value of Lₜₒₜ′ is 4, it may be determined that a maximum bit width occupied by a number of SD basis vectors corresponding to each CSI-RS resource is

$$⌈ {log}_{2}^{{L}_{tot}^{′}} ⌉ = 2 ,$$

and further because N_{TRP}=3, it may be determined that a bit width occupied by the first information is (3−1)*2=4 bits.

Optionally, if the first parameter is Y, and Y=25, it may be determined that the bit width occupied by the first information is:

$$⌈ {log}_{2}^{Y} ⌉ = 5 .$$

Step 303, determining the first information based on a number of selected SD basis vectors corresponding to each CSI-RS resource.

For example, if the bit width occupied by the first information is 9 bits, and N_{TRP}=3, and it is determined that L₁=3, L₂=2 and L₃=1 as selected by the terminal device, the terminal device can determine the first information as 011010001.

Step 304: sending the CSI to the network device.

For specific implementation forms of step 303 and step 304, the detailed description of any embodiment of the present disclosure can be referred to, and details will not be repeated herein.

In the present disclosure, if the first parameter is any one of: L, Lₘₐₓ, Lₜₒₜ, Lₘₐₓ′, Lₜₒₜ′, X and Y, the terminal device may determine, based on

$$⌈ {log}_{2}^{T} ⌉ ,$$

the bit width occupied by the first information, then determine the first information based on the number of actually selected SD basis vectors corresponding to the CSI-RS resources, and send the CSI to the network device. In such way, it is ensured that the terminal device and the network device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

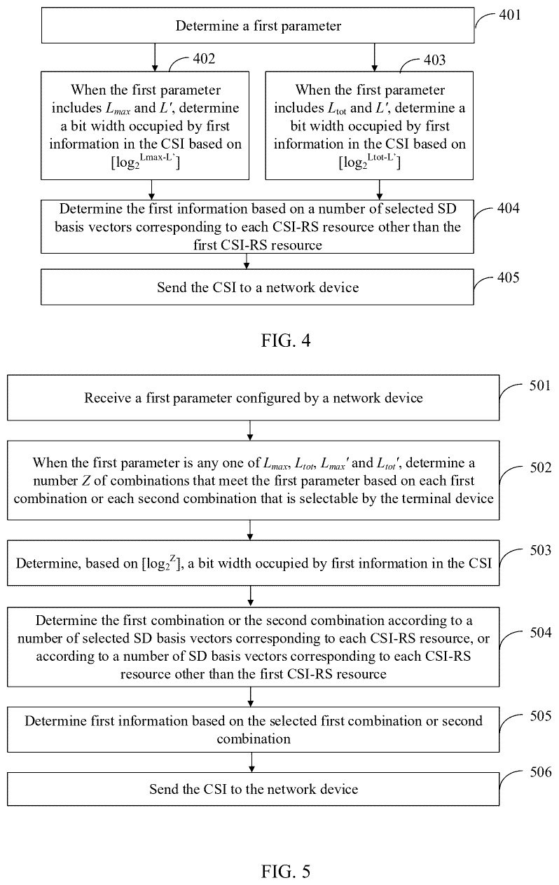

Referring to FIG. 4, FIG. 4 is a schematic flowchart of another method for determining channel state information (CSI) according to an embodiment of the present disclosure. The method is performed by a terminal device. As shown in FIG. 4, the method may include but is not limited to following steps.

Step 401, determining a first parameter.

For specific implementation forms of step 401, the detailed description of any embodiment of the present disclosure can be referred to, and details will not be repeated herein. Depending on the first parameter, either Step 402 or 403 is performed.

Step 402, when the first parameter includes Lₘₐₓ and L′, determining a bit width occupied by first information in the CSI based on

$$⌈ {log}_{2}^{{L}_{max} - {L}^{′}} ⌉ .$$

For example, if N_{TRP}=3, the first parameter Lₘₐₓ=7, L′=2, it may be determined that the number of SD basis vectors corresponding to each of the two CSI-RS resources other than the first CSI-RS resource is 5, that is, the maximum bit width occupied by the number of SD basis vectors corresponding to each of the two CSI-RS resources is

$$⌈ {log}_{2}^{{L}_{max} - {L}^{′}} ⌉ = 3 ,$$

and further N_{TRP}=3, so it may be determined that the bit width occupied by the first information is (3−1)*3=6 bits.

Alternatively, in Step 403, when the first parameter includes Lₜₒₜ and L′, determining a bit width occupied by first information in the CSI based on

$$⌈ {log}_{2}^{{L}_{tot} - {L}^{′}} ⌉ .$$

For example, if N_{TRP}=3, the first parameter Lₜₒₜ=8 and L′=2, it can be determined that the maximum number of SD basis vectors corresponding to each of the two CSI-RS resources other than the first CSI-RS resource is 6, that is, the maximum bit width occupied by the number of SD basis vectors corresponding to each of the two CSI-RS resources is:

$$⌈ {log}_{2}^{{L}_{tot} - {L}^{′}} ⌉ = 3 ,$$

and further N_{TRP}=3, so it can be determined that the bit width occupied by the first information is (3−1)*3=6 bits.

It should be noted that, in this case, the terminal device further needs to know which one of the resources is the first CSI-RS resource.

Optionally, the terminal device may determine the first CSI-RS resource based on agreement in a protocol; or determine the first CSI-RS resource based on an indication of the network device; or determine the first CSI-RS resource based on a measurement result of each CSI-RS resource.

For example, the terminal device may measure each CSI-RS resource, and determine a CSI-RS resource with best measurement result quality as the first CSI-RS resource.

In some possible implementations, after determining the first CSI-RS resource, the terminal device further needs to report the first CSI-RS resource to the network device. Optionally, the first CSI-RS resource may be indicated to the network device by using second information in the CSI.

Optionally, the terminal device may determine, based on the corresponding maximum number of coordinated TRPs, a bit width occupied by the second information. For example, when N_{TRP}=3, it may be determined that bit width occupied by the second information=

$$⌈ {log}_{2}^{{N}_{TRP}} ⌉ = 2 .$$

In this case, if the second information is 00, it indicates that the first CSI-RS resource selected by the terminal device is the first one of the CSI-RS resources. If the second information is 01, it indicates that the first CSI-RS resource selected by the terminal device is the second one of the CSI-RS resources. If the second information is 10, it indicates that the first CSI-RS resource selected by the terminal device is the third one of the CSI-RS resources.

Optionally, the second information may be included in part1 of the reported CSI.

After either Step 402 or Step 403 is performed, Step 404 is performed. Step 404, determining the first information based on a number of selected SD basis vectors corresponding to each CSI-RS resource other than the first CSI-RS resource.

For example, if the bit width occupied by the first information is 9 bits, and N_{TRP}=3, and it is determined that L₁=3, L₂=2 and L₃=1 as selected by the terminal device, the terminal device may determine that the first information is 011010001.

Step 405, sending the CSI to a network device.

For specific implementation forms of step 404 and step 405, the detailed description of any embodiment of the present disclosure can be referred to, and details will not be repeated herein.

In the present disclosure, if the first parameter is Lₘₐₓ′ and L′, or Lₜₒₜ′ and L′, the terminal device may determine, based on a related formula, a bit width occupied by the first information, then determine the first information based on a number of actually selected SD basis vectors corresponding to an CSI-RS resource, and send the CSI to the network device. In such way, it is ensured that the terminal device and the network device comprehend the first information in a same way, which provides conditions for the network device to accurately determine the number of SD basis vectors corresponding to each CSI-RS resource selected by the terminal device, and hence ensures that the network device can accurately calculate precoding for downlink data transmission.

Referring to FIG. 5, FIG. 5 is a schematic flowchart of another method for determining channel state information (CSI) according to an embodiment of the present disclosure. The method is performed by a terminal device. As shown in FIG. 5, the method may include but is not limited to following steps.

Step 501, receiving a first parameter configured by a network device.

For specific implementation forms of step 501, the detailed description of any embodiment of the present disclosure can be referred to, and details will not be repeated herein.

Step 502, when the first parameter is any one of Lₘₐₓ, Lₜₒₜ, Lₘₐₓ′ and Lₜₒₜ′, determining a number Z of combinations that meet the first parameter based on each first combination or each second combination that is selectable by the terminal device.

Step 503, determining, based on

$$⌈ {log}_{2}^{Z} ⌉ ,$$

a bit width occupied by first information in the CSI.

For example, if 3 CSI-RS resources are configured for the terminal device, and a maximum number of SD basis vectors corresponding to each CSI-RS is 4, a set of candidate numbers of SD basis vectors corresponding to each CSI-RS resource is {0, 1, 2, 3, 4}. Therefore, the first combination may include {0, 0, 0}, {0, 0, 1}, {0, 1, 0}, {0, 1, 1}, etc. If Lₜₒₜ=5, it is indicated that a sum of numbers of all basis vectors in the first combination selected by the terminal device is 5, the first combination that meets the condition may be any one of: {4, 1, 0}, {3, 2, 0}, {2, 3, 0}, {1, 4, 0}, {4, 0, 1}, {3,1,1}, {2,2,1}, {1,3,1}, {0,4,1}, {3,0,2}, {2,1,2}, {1,2,2}, {0,3,2}, {2,0,3}, {1,1,3}, {0,2,3}. That is, if Lₜₒₜ=5, a number of combinations that meet the condition is 16. Then, it may be determined that the bit width occupied by the first information is

$$⌈ {log}_{2}^{16} ⌉ = 4 .$$

Optionally, if the terminal device is configured with 3 CSI-RS resources, and the number of SD basis vectors corresponding to the first CSI-RS resource is 2 according to agreement in a protocol or as indicated by a network device, and the maximum number of SD basis vectors corresponding to each of the other two CSI-RS resources is 4, a set of candidate numbers of SD basis vectors corresponding to each CSI-RS resource is {0, 1, 2, 3, 4}. Therefore, the second combination may include {0, 0}, {0, 1}, {1, 0}, {1, 1}, etc. If Lₘₐₓ′=3, it is indicated that a sum of numbers of all basis vectors in the second combination selected by the terminal device cannot be greater than 3, the second combination that meets the condition may be any one of: {0, 0}, {0, 1}, {1, 0}, {1, 1}, {0, 2}, {2, 0}, {2, 1}, {1, 2}, {3, 0} and {0, 3}. That is, if Lₘₐₓ′=3, a number of combinations that meet the condition is 10. Then, it may be determined that the bit width occupied by the first information is

$$⌈ {log}_{2}^{10} ⌉ = 4 .$$

Optionally, if the terminal device is configured with 3 CSI-RS resources, and the number of SD basis vectors corresponding to the first CSI-RS resource is 2 according to agreement in a protocol or as indicated by a network device, and the maximum number of SD basis vectors corresponding to each of the other two CSI-RS resources is 4, a set of candidate numbers of SD basis vectors corresponding to each CSI-RS resource is {0, 1, 2, 3, 4}. Therefore, the second combination may include {0, 0}, {0, 1}, {1, 0}, {1, 1}, etc. If Lₜₒₜ′=3, a sum of numbers of all basis vectors in the second combination selected by the terminal device is 3, the second combination that meets the condition may be any one of: {2, 1}, {1, 2}, {3, 0} and {0, 3}. That is, if Lₜₒₜ′=3, the number of combinations that meet the condition is 4. Then, it may be determined that the bit width occupied by the first information is

$$⌈ {log}_{2}^{4} ⌉ = 2.$$

Optionally, the terminal device may determine each first combination or second combination according to agreement in a protocol; or the terminal device may receive each first combination or second combination sent by the network device.

Step 504, determining the first combination or the second combination according to a number of selected SD basis vectors corresponding to each CSI-RS resource, or according to a number of SD basis vectors corresponding to each CSI-RS resource other than the first CSI-RS resource.

Step 505, determining first information based on the selected first combination or second combination.

It can be learned from the included examples that when the first parameter is Lₘₐₓ, Lₜₒₜ, Lₘₐₓ′ or Lₜₒₜ′, there may be a plurality of first combinations or second combinations that meet the first parameter, and in order to enable the terminal device and the network device to understand the first combinations or the second combinations indicated by the first information in a same way, in the present disclosure, the first combinations and the second combinations may be sorted separately. Therefore, after determining the corresponding first combination or second combination based on the number of selected SD basis vectors corresponding to each CSI-RS resource, the terminal device may directly indicate, by using the first information, a sequence number of the selected first combination or second combination. Optionally, in the present disclosure, the first combinations or the second combinations may be sorted according to an order that a sum of numbers in the combinations increases (or decreases), and numbers in each combination increases (or decreases) from right to left.

For example, if the first combination includes a number of SD basis vectors corresponding to 3 CSI-RSs, and a maximum number of SD basis vectors corresponding to each CSI-RS is 3, sorting of the first combinations may be: {0, 0, 0}, {0, 0, 1}, {0, 1, 0}, {1, 0, 0}, {0, 1, 1}, {1, 0, 1}, {0, 0, 2}, {0, 2, 0}, {2, 0, 0}, etc.

Optionally, in the present disclosure, a number of SD basis vectors in each of the first combinations or the second combinations may be first calculated to obtain certain values, and then the first combinations or the second combinations are sorted in ascending order (or descending order) based on the calculated value.

For example, the first combination includes 3 numbers of SD basis vectors, that is, the first combination is {x₁,x₂,x₃}, and an operation rule is: x₁+ax₂+a²x₃, where a is a random number. For example, if a=10, and a maximum number of SD basis vectors corresponding to each CSI-RS is 3, the first combinations may be sorted as follows: {0, 0, 0}, {1, 0, 0}, {2, 0, 0}, {3, 0, 0}, {0, 1, 0}, {0, 2, 0}, {0, 3, 0}, {1, 1, 0}, {1, 2, 0}, {1, 3, 0}, {1, 1, 1}, etc. In this case, if the first combination selected by the network device is {1, 3, 0}, as an order of this combination in the combinations is 9th, the first information in the CSI may be: 101.

Step 506, sending the CSI to the network device.

For specific implementation forms of step 506, the detailed description of any embodiment of the present disclosure can be referred to, and details will not be repeated herein.

In the present disclosure, after determining the first parameter, the terminal device first determines the number of combinations that meet the first parameter based on the selectable first combinations or second combinations, then determines the bit width occupied by the first information based on the number of combinations that meet the first parameter, then determines a sequence number of the selected combination based on the number of actually selected SD basis vectors corresponding to the CSI-RS resource, and then determines the first information based on the sequence number of the selected combination, and sends the CSI to the network device. In such way, it is ensured that the terminal device and the network device comprehend the first information in a same way, which provides conditions for the network device to accurately determine the number of SD basis vectors corresponding to each CSI-RS resource selected by the terminal device, and hence ensures that the network device can accurately calculate precoding for downlink data transmission.

Referring to FIG. 6, FIG. 6 is a schematic flowchart of another method for determining channel state information (CSI) according to an embodiment of the present disclosure. The method is performed by a network device. As shown in FIG. 6, the method may include but is not limited to following step.

Step 601, determining, according to a first parameter, a bit width occupied by first information in the CSI reported by the terminal device, where the first information indicates a number of space domain (SD) basis vectors selected by the terminal device corresponding to one or more CSI-RS resources.

In the present disclosure, as the first information indicates, to the network device, the number of SD basis vectors corresponding to one or more CSI-RS resources selected by the terminal device, that is, the first information may include a number of SD basis vectors corresponding to one CSI-RS resource, or may include a number of SD basis vectors corresponding to a plurality of CSI-RS resources. To ensure that the network device and the terminal device have same comprehension of the first information, it needs to be ensured that the network device and the terminal device have same comprehension of the bit width occupied by the first information. In the present disclosure, the network device may determine the bit width occupied by the first information in a same way as the terminal device does.

Optionally, the first parameter may be determined by the network device based on agreement in a protocol.

Optionally, the network device may also configure the determined first parameter for the terminal device. For example, the network device may configure the first parameter for the terminal device by using high-layer signaling, for example, the network device may configure the first parameter for the terminal device by using one or more of a radio resource control (RRC) message, a medium access control control element (MAC-CE), or downlink control information (DCI) signaling.

In other words, the network device may determine the bit width occupied by the first information in the CSI based on the same first parameter as the terminal device does, thereby ensuring that the terminal device and the network device understand the first information in a same way, so that the network device can accurately determine the number of SD basis vectors corresponding to each CSI-RS resource selected by the terminal device, thereby ensuring that the network device can accurately calculate the precoding used for downlink data transmission.

Optionally, the first parameter may include at least one of: a maximum selectable number L of SD basis vectors corresponding to each of the CSI-RS resources; a maximum value Lₘₐₓ of a sum of a number of SD basis vectors selectable by the terminal device corresponding to all CSI-RS resources; a sum Lₜₒₜ of a number of SD basis vectors selectable by the terminal device corresponding to all CSI-RS resources; a maximum number X of first combinations, where a value of an i-th element in each of the first combinations represents a number of SD basis vectors selected by the terminal device corresponding to an i-th CSI-RS resource in all CSI-RS resources, where i is a natural number; a maximum number Y of second combinations, where a value of a j-th element in each of the second combinations represents a number of SD basis vectors selected by the terminal device corresponding to a j-th CSI-RS resource in CSI-RS resources other than a first CSI-RS resource, where j is a natural number; a number L′ of SD basis vectors corresponding to the first CSI-RS resource; a sum Lₜₒₜ′ of a number of SD basis vectors selectable by the terminal device corresponding to CSI-RS resources other than the first CSI-RS resource; or a maximum value Lₘₐₓ′ of the sum of a number of SD basis vectors selectable by the terminal device corresponding to CSI-RS resources other than the first CSI-RS resource.

L refers to that when the terminal device is selecting SD basis vectors corresponding to each CSI-RS resource, a maximum number of the SD basis vectors must not exceed L. For example, if Lₙ=5, when the terminal device is selecting SD basis vectors corresponding to an n-th CSI-RS resource, the terminal device may select 0, 1, 2, 3, 4 or 5 SD basis vectors.

In addition, Lₘₐₓ indicates that a sum of a number of all SD basis vectors selected by the terminal device cannot exceed a maximum value Lₘₐₓ. For example, if Lₘₐₓ=10, when the terminal device is configured to use 3 TRPs for CJT transmission, a sum of numbers Lₙ of basis vectors corresponding to each CSI-RS resource selected by the terminal device is less than or equal to 10, that is, L₁+L₂+L₃≤10.

In addition, Lₜₒₜ indicates that a sum of a number of all SD basis vectors that need to be selected by the terminal device is Lₜₒₜ. For example, if Lₜₒₜ=7, when the terminal device is configured to use 3 TRPs for CJT transmission, a sum of numbers Lₙ of basis vectors corresponding to each selected CSI-RS resource is equal to 7, that is, L₁+L₂+L₃=7.

The first combinations refer to combinations of numbers of SD basis vectors selected by the terminal device from SD basis vectors corresponding to all CSI-RS resources. For example, if 3 CSI-RS resources are configured for the terminal device, and a maximum number of SD basis vectors corresponding to each CSI-RS is 4, a set of candidate numbers of SD basis vectors corresponding to each CSI-RS resource is {0, 1, 2, 3, 4}. Thus, a maximum number of the first combinations is X=5*5*5=125. For example, a first combination being {0, 0, 0} indicates that a number of SD basis vectors corresponding to each CSI-RS resource selected by the terminal device is 0; and a first combination being {0, 0, 1}, indicates that a number of SD basis vectors corresponding to first and second CSI-RS resources selected by the terminal device is 0, and a number of SD basis vectors corresponding to a third CSI-RS resource is 1.

The second combinations are combinations of numbers of SD basis vectors selected by the terminal device from SD basis vectors corresponding to CSI-RS resources other than the first CSI-RS resource. For example, if the terminal device is configured with 3 CSI-RS resources, and a maximum number of SD basis vectors corresponding to two CSI-RS resources other than the first CSI-RS resource is 4, a set of candidate numbers of SD basis vectors corresponding to each of the two CSI-RS resources is {0, 1, 2, 3, 4}. Thus, a maximum number of second combinations is Y=5*5=25. For example, a second combination being {0, 1} indicates that a number of SD basis vectors corresponding to a first one of CSI-RS resources other than the first CSI-RS resource selected by the terminal device is 0, and a number of SD basis vectors corresponding to a second one of CSI-RS resources is 1.

Lₜₒₜ′ refers to a sum of a number of SD basis vectors corresponding to other CSI-RS resources except the first CSI-RS resource that the terminal device needs to select. For example, if Lₜₒₜ′=5, when the terminal device is configured to use 3 TRPs for CJT transmission, a sum of a number of basis vectors corresponding to two CSI-RS resources other than the first CSI-RS resource that need to be selected is 5.

Lₘₐₓ′ refers to that a sum of a number of all SD basis vectors corresponding to other CSI-RS resources except the first CSI-RS resource selected by the terminal device cannot exceed a maximum number Lₘₐₓ′. For example, if Lₘₐₓ=7, when the terminal device is configured to use 3 TRPs for CJT transmission, a sum of a number of basis vectors corresponding to CSI-RS resources other than the first CSI-RS resource selected by the terminal device should be less than or equal to 7. Optionally, the number of SD basis vectors corresponding to each CSI-RS resource selected by the terminal device may be indicated by using content of the first information, for example, a value of each bit in the first information.

For example, the terminal device is configured to perform CJT based on 3 TRPs, and it is determined, based on the first parameter, that a bit width occupied by the first information is 9, that is, a number of SD basis vectors corresponding to each CSI-RS resource occupies 3 bits. In this case, the terminal device may first calculate a receive power of each candidate SD basis vector based on estimated and measured downlink channel information from each TRP to the terminal device and candidate SD basis vectors, and after sorting the receive powers, the terminal device may determine that a number of SD basis vectors corresponding to each CSI-RS resource is Lₙ, for example, L₁=3, L₂=2, and L₃=1. Further, the terminal device may further determine a combination coefficient in a codebook structure based on the selected SD basis vectors corresponding to each CSI-RS resource, and then further determine a number of SD basis vectors corresponding to each CSI-RS resource, for example, L₁=2, L₂=2 and L₃=1. In this case, it may be determined that a value of each bit in the first information is 010010001.

After determining the content of the first information in the CSI, the terminal device may send the CSI to the network device, so that the network device parses the first information based on the same understanding as the terminal device on the bit width occupied by the first information, to determine the SD basis vectors selected by the terminal device corresponding to the one or more CSI-RS resources.

It should be noted that after the network device determines the bit width occupied by the first information based on the first parameter, if the first parameter does not change when the terminal device reports the CSI, the network device may keep understanding of the bit width occupied by the first information unchanged, and parse the newly received CSI report.

For example, if the network device parses, after receiving the CSI reported by the terminal device, the first information in the CSI based on the determined bit width occupied by the first information, the SD basis vectors corresponding to the one or more CSI resources currently selected by the terminal device may be determined. When the first parameter does not change, if the network device receives the CSI reported by the terminal device again, the network device may continue to parse the first information in the newly received CSI by using the known bit width occupied by the first information.

If the first parameter is updated, the network device needs to re-determine, based on the updated first parameter, the bit width occupied by the first information.

For example, when the terminal device reports CSI for the first time, if a bit width occupied by the first information is 9, and then the first parameter is updated, and the network device determines, based on the updated first parameter, that the bit width occupied by the first information is 6, when new CSI reporting is received, the first information needs to be parsed based on the bit width occupied by the first information being 6.

In some possible embodiments, the first information may be included in a first part (part1) of the reported CSI.

In the present disclosure, the network device may determine the bit width occupied by the first information in the CSI based on the first parameter in the same way as the terminal device does. In such way, it is ensured that the network device and the terminal device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

Referring to FIG. 7, FIG. 7 is a schematic flowchart of another method for determining channel state information (CSI) according to an embodiment of the present disclosure. The method is performed by a network device. As shown in FIG. 7, the method may include but is not limited to following steps.

Step 701, determining a first parameter according to agreement in a protocol.

The first parameter includes any one of: a maximum selectable number L of SD basis vectors corresponding to each of the CSI-RS resources; a maximum value Lₘₐₓ of a sum of a number of SD basis vectors selectable by the terminal device corresponding to all CSI-RS resources; a sum Lₜₒₜ of a number of SD basis vectors selectable by the terminal device corresponding to all CSI-RS resources; a maximum number X of first combinations, where a value of an i-th element in each of the first combinations represents a number of SD basis vectors selected by the terminal device corresponding to an i-th CSI-RS resource in all CSI-RS resources, where i is a natural number; a maximum number Y of second combinations, where a value of a j-th element in each of the second combinations represents a number of SD basis vectors selected by the terminal device corresponding to a j-th CSI-RS resource in CSI-RS resources other than a first CSI-RS resource, where j is a natural number; a sum Lₜₒₜ′ of a number of SD basis vectors selectable by the terminal device corresponding to CSI-RS resources other than the first CSI-RS resource; or a maximum value Lₘₐₓ′ of the sum of a number of SD basis vectors selectable by the terminal device corresponding to CSI-RS resources other than the first CSI-RS resource.

The meaning of the “first parameter” can be referred from the detailed description of any embodiment of the present disclosure, which will not be repeated herein.

Optionally, the network device may also configure the first parameter for the terminal device by using high-layer signaling, for example, the network device may configure the first parameter for the terminal device by using one or more of a radio resource control (RRC) message, a medium access control control element (MAC-CE), or downlink control information (DCI) signaling.

Step 702, determining a bit width occupied by first information in the CSI based on

$$⌈ {log}_{2}^{T} ⌉ ,$$

where T represents the first parameter.

For example, if the network device configures 3 TRPs for the terminal device for CJT transmission, where the first parameter is L, and a value of L is 5, that is, when the terminal device selects and reports the SD basis vectors corresponding to each CIS-RS resource, a number of the SD basis vectors does not exceed 5, and it can be determined that a maximum bit width occupied by the number of SD basis vectors corresponding to each CSI-RS resource is

$$⌈ {log}_{2}^{5} ⌉ = 3 ,$$

further, N_{TRP}=3, thus it can be determined that a bitwidth occupied by the first information is 3*3=9 bits.

Optionally, if N_{TRP}=3, the first parameter is Lₘₐₓ, and a value of Lₘₐₓ is 8, that is, when the terminal device selects and reports the SD basis vectors corresponding to each CIS-RS resource, a number of the SD basis vectors does not exceed 8, it may be determined that a maximum bit width occupied by the number of SD basis vectors corresponding to each CSI-RS resource is

$$⌈ {log}_{2}^{{L}_{max}} ⌉ = 3 ,$$

and further N_{TRP}=³, so that it may be determined that a bit width occupied by the first information is 3*3=9 bits.

Optionally, if N_{TRP}=3, the first parameter is Lₜₒₜ, and a value of Lₜₒₜ is 6, that is, when the terminal device selects and reports the SD basis vectors corresponding to each CIS-RS resource, a number of the SD basis vectors does not exceed 6, it may be determined that a maximum bit width occupied by the number of SD basis vectors corresponding to each CSI-RS resource is

$$⌈ {log}_{2}^{{L}_{tot}} ⌉ = 3 ,$$

and further N_{TRP}=3, so that it may be determined that the bit width occupied by the first information is 3*3=9 bits.

In other words, the terminal device may first determine, based on the first parameter, the maximum bit width occupied by the number of SD basis vectors corresponding to each CSI-RS resource, and then determine the bit width occupied by the first information based on the maximum number of coordinated TRPs corresponding to the terminal device and the maximum bit width occupied by the SD basis vectors corresponding to each CSI-RS resource.

Optionally, if the first parameter is X, and X=125, it may be determined that the bit width occupied by the first information field is

$$⌈ {log}_{2}^{X} ⌉ = 7 .$$

In addition, it should be noted that if the first parameter is the number of SD basis vectors corresponding to the CSI-RS resources other than the first CSI-RS resource, it may be considered that the number of SD basis vectors corresponding to the first CSI-RS resource is known. For example, the network device may configure, for the terminal device, the number of SD basis vectors corresponding to the first CSI-RS resource, or the terminal device may determine, based on agreement in a protocol, the number of SD basis vectors corresponding to the first CSI-RS resource.

In other words, in this case, the terminal device only needs to report, to the network device, the number of SD basis vectors corresponding to the CSI-RS resources other than the first CSI-RS resource. Correspondingly, the bit width occupied by the first information may be determined only [symbol] based on the first parameter (for example, Lₘₐₓ′ [symbol] Lₜₒₜ, or Y) used to represent the number of SD basis vectors corresponding to the CSI-RS resources other than the first CSI-RS resource.

For example, if N_{TRP}=3, the first parameter is Lₘₐₓ′, and a value of Lₘₐₓ′ is 6, it may be determined that a maximum bit width occupied by a number of SD basis vectors corresponding to CSI-RS resources other than the first CSI-RS resource is

$$⌈ {log}_{2}^{{L}_{{max}^{′}}} ⌉ = 3 ,$$

and further because N_{TRP}=3, it may be determined that a bit width occupied by the first information is 2*3=6 bits.

Optionally, if N_{TRP}=3, the first parameter is Lₜₒₜ′, and a value of Lₜₒₜ′ is 4, it may be determined that a maximum bit width occupied by a number of SD basis vectors corresponding to each CSI-RS resource is

$$⌈ {log}_{2}^{{L}_{{tot}^{′}}} ⌉ = 2 ,$$

and further because N_{TRP}=3, it may be determined that a bit width occupied by the first information is (3−1)*2=4 bits.

Optionally, if the first parameter is Y, and Y=25, it may be determined that the bit width occupied by the first information is:

$$⌈ {log}_{2}^{X} ⌉ = 5 .$$

Step 703, receiving the CSI sent by a terminal device.

Step 704, determining, according to the first information in the CSI, the number of SD basis vectors selected by the terminal device corresponding to the one or more CSI-RS resources.

For specific implementation forms of step 703 and step 704, the detailed description of any embodiment of the present disclosure can be referred to, and details will not be repeated herein.

It should be noted that if the number of the SD basis vectors corresponding to the first CSI-RS resource is configured by the network device for the terminal device, or is agreed according to a protocol, in this case, as the network device knows the number of SD basis vectors corresponding to the first CSI-RS resource, the terminal device may indicate, to the network device by using the first information, only the number of SD basis vectors corresponding to one or more non-configured CSI-RS resources. In this case, if the number of the SD basis vectors corresponding to the first CSI-RS resource is not configured by the network device for the terminal device, or is not agreed according to a protocol, the terminal device needs to indicate, to the network device by using the first information, the number of SD basis vectors corresponding to each CSI-RS resource in the CJT transmission.

In the present disclosure, if the first parameter includes any one of L, Lₘₐₓ, Lₜₒₜ, Lₘₐₓ′, Lₜₒₜ′, X and Y, the network device may determine, based on

$$⌈ {log}_{2}^{T} ⌉ ,$$

the bit width occupied by the first information, and then determine, based on the first information in the received CSI sent by the terminal device, the number of SD basis vectors selected by the terminal device corresponding to the one or more CSI-RS resources. In such way, it is ensured that the terminal device and the network device comprehend the first information in a same way, which provides conditions for the network device to accurately determine the number of SD basis vectors corresponding to each CSI-RS resources selected by the terminal device, and hence ensures that the network device can accurately calculate precoding for downlink data transmission.

Referring to FIG. 8, FIG. 8 is a schematic flowchart of another method for determining channel state information (CSI) according to an embodiment of the present disclosure. The method is performed by a network device. As shown in FIG. 8, the method may include but is not limited to following steps.

Step 801, determining a first parameter.

For specific implementation forms of step 801, the detailed description of any embodiment of the present disclosure can be referred to, and details will not be repeated herein. Depending on the first parameter, either Step 802 or 803 is performed.

Step 802, when the first parameter includes Lₘₐₓ and L′, determining a bit width occupied by first information in the CSI based on

$$⌈ {log}_{2}^{{L}_{{max}^{′}} - {L}^{′}} ⌉ .$$

For example, if N_{TRP}=3, and the first parameter Lₘₐₓ=7, L′=2, it may be determined that the number of SD basis vectors corresponding to each of two CSI-RS resources other than the first CSI-RS resource is 5, that is, a maximum bit width occupied by the number of SD basis vectors corresponding to each of the two CSI-RS resources is:

$$⌈ {log}_{2}^{{L}_{{max}^{′}} - {L}^{′}} ⌉ = 3 ,$$

and further N_{TRP}=3, so it may be determined that the bit width occupied by the first information is: (3−1)*3=6 bits.

Alternatively, Step 803, when the first parameter includes Lₜₒₜ and L′, determining a bit width occupied by first information in the CSI based on

$$⌈ {log}_{2}^{{L}_{tot} - {L}^{′}} ⌉ .$$

For example, if N_{TRP}=3, and the first parameter Lₜₒₜ=8, L′=2, it can be determined that the maximum number of SD basis vectors corresponding to each of two CSI-RS resources other than the first CSI-RS resource is 6, that is, the maximum bit width occupied by the number of SD basis vectors corresponding to each of the two CSI-RS resources is:

$$⌈ {log}_{2}^{{L}_{tot} - {L}^{′}} ⌉ = 3 ,$$

and further N_{TRP}=3, so it can be determined that the bit width occupied by the first information is: (3−1)*3=6 bits.

It should be noted that, in this case, the network device further needs to determine which one of the resources is the first CSI-RS resource.

Optionally, the network device may determine the first CSI-RS resource according to agreement in a protocol.

Optionally, the network device may also determine the first CSI-RS resource based on second information included in the CSI. In other words, the terminal device may measure each CSI-RS resource, determine a CSI-RS resource with best measurement result quality as the first CSI-RS resource, and then indicate the determined first CSI-RS resource to the network device by using the second information in the reported CSI.

Optionally, the first CSI-RS resource may be indicated to the network device by using second information in the CSI.

Optionally, the network device may determine the bit width occupied by the second information based on the maximum number of coordinated TRPs of the terminal device. For example, N_{TRP}=3, it may be determined that the bit width occupied by the second information=

$$⌈ {log}_{2}^{{N}_{TRP}} ⌉ = 2 .$$

In this case, if the second information is 00, it indicates that the first CSI-RS resource selected by the terminal device is the first one of the CSI-RS resources. If the second information is 01, it indicates that the first CSI-RS resource selected by the terminal device is the second one of the CSI-RS resources. If the second information is 10, it indicates that the first CSI-RS resource selected by the terminal device is the third one of the CSI-RS resources.

Optionally, the second information may be included in part1 of the reported CSI.

After either Step 802 or Step 803 is performed, Step 804 is performed. Step 804, receiving the CSI sent by a terminal device.

Step 805, determining, according to the first information in the CSI, the number of SD basis vectors selected by the terminal device corresponding to the one or more CSI-RS resources.

For specific implementation forms of step 804 and step 805, the detailed description of any embodiment of the present disclosure can be referred to, and details will not be repeated herein.

In the present disclosure, if the first parameter includes Lₘₐₓ′ and L′, or Lₜₒₜ′ and L′, the network device may determine, based on a related formula, a bit width occupied by the first information, and after receiving CSI sent by the terminal device, parse the first information based on the determined bit width occupied by the first information, to determine a number of SD basis vectors corresponding to the CSI-RS resource actually selected by the terminal device. In such way, it is ensured that the network device and the terminal device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

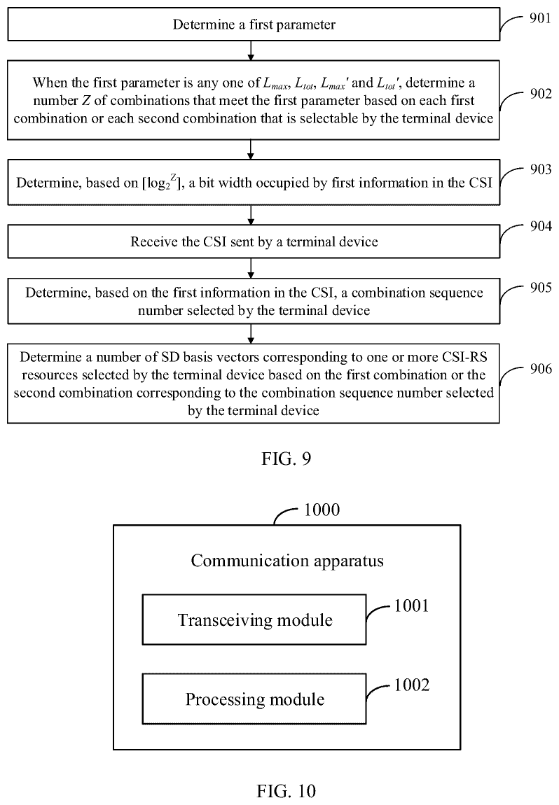

Referring to FIG. 9, FIG. 9 is a schematic flowchart of another method for determining channel state information (CSI) according to an embodiment of the present disclosure. The method is performed by a network device. As shown in FIG. 9, the method may include but is not limited to following steps:

Step 901, determining a first parameter.

For specific implementation forms of step 901, the detailed description of any embodiment of the present disclosure can be referred to, and details will not be repeated herein.

Step 902, when the first parameter includes any one of Lₘₐₓ, Lot, Lₘₐₓ′ and Lₜₒₜ′, determining a number Z of combinations that meet the first parameter based on each first combination or each second combination that is selectable by the terminal device.

Step 903, determining, based on

$$⌈ {log}_{2}^{Z} ⌉ ,$$

a bit width occupied by first information in the CSI.

For example, if 3 CSI-RS resources are configured for the terminal device by the network device, and a maximum number of SD basis vectors corresponding to each CSI-RS is 4, a set of candidate numbers of SD basis vectors corresponding to each CSI-RS resource is {0, 1, 2, 3, 4}. Therefore, the first combination may include {0, 0, 0}, {0, 0, 1}, {0, 1, 0}, {0, 1, 1}, etc. If Lₜₒₜ=5, a sum of numbers of all basis vectors in the first combination selected by the terminal device is 5, hence the first combination that meets the condition may include any one of: {4, 1, 0}, {3, 2, 0}, {2, 3, 0}, {1, 4, 0}, {4, 0, 1}, {3,1,1}, {2,2,1}, {1,3,1}, {0,4,1}, {3,0,2}, {2,1,2}, {1,2,2}, {0,3,2}, {2,0,3}, {1,1,3}, {0,2,3}. That is, if Lₜₒₜ=5, a number of combinations that meet the condition is 16. Then, it may be determined that the bit width occupied by the first information is

$$⌈ {log}_{2}^{16} ⌉ = 4.$$

Optionally, if the terminal device is configured with 3 CSI-RS resources by the network device, and the number of SD basis vectors corresponding to the first CSI-RS resource is 2 according to agreement in a protocol or as indicated by a network device, and the maximum number of SD basis vectors corresponding to each of the other two CSI-RS resources is 4, a set of candidate numbers of SD basis vectors corresponding to each CSI-RS resource is {0, 1, 2, 3, 4}. Therefore, the second combination may include {0, 0}, {0, 1}, {1, 0}, {1, 1}, etc. If Lₘₐₓ′=3, it is indicated that a sum of numbers of all basis vectors in the second combination selected by the terminal device cannot be greater than 3, the second combination that meets the condition may be any one of: {0, 0}, {0, 1}, {1, 0}, {1, 1}, {0, 2}, {2, 0}, {2, 1}, {1, 2}, {3, 0}, and {0, 3}. That is, if Lₘₐₓ′=3, a number of combinations that meet the condition is 10. Then, it may be determined that the bit width occupied by the first information is

$$⌈ {log}_{2}^{10} ⌉ = 4 .$$

Optionally, if the terminal device is configured with 3 CSI-RS resources by the network device, and the number of SD basis vectors corresponding to the first CSI-RS resource is 2 according to agreement in a protocol or as indicated by a network device, and the maximum number of SD basis vectors corresponding to each of the other two CSI-RS resources is 4, a set of candidate numbers of SD basis vectors corresponding to each CSI-RS resource is {0, 1, 2, 3, 4}. Therefore, the second combination may include {0, 0}, {0, 1}, {1, 0}, {1, 1}, etc. If Lₜₒₜ′=3, a sum of numbers of all basis vectors in the second combination selected by the terminal device is 3, the second combination that meets the condition may be any one of: {2, 1}, {1, 2}, {3, 0}, and {0, 3}. That is, if Lₜₒₜ′=3, the number of combinations that meet the condition is 4. Then, it may be determined that the bit width occupied by the first information is

$$⌈ {log}_{2}^{4} ⌉ = 2 .$$

Optionally, the network device may determine each first combination or each second combination according to agreement in a protocol.

Optionally, the network device may further configure each first combination or each second combination for the terminal device.

Step 904, receiving the CSI sent by a terminal device.

Step 905, determining, based on the first information in the CSI, a combination sequence number selected by the terminal device.

The combination sequence number may uniquely identify a combination selected by the terminal device as a specific combination in the first combination or the second combination.

For specific implementation forms of step 904 and step 905, the detailed description of any embodiment of the present disclosure can be referred to, and details will not be repeated herein.

Step 906, determining a number of SD basis vectors corresponding to one or more CSI-RS resources selected by the terminal device based on the first combination or the second combination corresponding to the combination sequence number selected by the terminal device.

It can be learned from the included examples that when the first parameter is Lₘₐₓ, Lₜₒₜ, Lₘₐₓ′ or Lₜₒₜ′, there may be a plurality of first combinations or second combinations that meet the first parameter, and in order to enable the terminal device and the network device to understand the first combinations or the second combinations indicated by the first information in a same way, in the present disclosure, the first combinations and the second combinations may be sorted separately. Therefore, after determining the corresponding first combination or second combination based on the number of selected SD basis vectors corresponding to each CSI-RS resource, the terminal device may directly indicate, by using the first information, a sequence number of the selected first combination or second combination. Optionally, in the present disclosure, the first combinations or the second combinations may be sorted according to an order that a sum of numbers in the combinations increases (or decreases), and numbers in each combination increases (or decreases) from right to left.

For example, if the first combination includes a number of SD basis vectors corresponding to 3 CSI-RSs, and a maximum number of SD basis vectors corresponding to each CSI-RS is 3, sorting of the first combinations may be: {0, 0, 0}, {0, 0, 1}, {0, 1, 0}, {1, 0, 0}, {0, 1, 1}, {1, 0, 1}, {0, 0, 2}, {0, 2, 0}, {2, 0, 0}, etc.

Optionally, in the present disclosure, a number of SD basis vectors in each of the first combinations or the second combinations may be first calculated to obtain certain values, and then the first combinations or the second combinations are sorted in ascending order (or descending order) based on the calculated value.

For example, the first combination includes 3 numbers of SD basis vectors, that is, the first combination is {x₁,x₂,x₃}, and an operation rule is: x₁+ax₂+a²x₃, where a is a random number. For example, if a=10, and a maximum number of SD basis vectors corresponding to each CSI-RS is 3, the first combinations may be sorted as follows: {0, 0, 0}, {1, 0, 0}, {2, 0, 0}, {3, 0, 0}, {0, 1, 0}, {0, 2, 0}, {0, 3, 0}, {1, 1, 0}, {1, 2, 0}, {1, 3, 0}, {1, 1, 1}, etc. In this case, if the first combination selected by the network device is {1, 3, 0}, as an order of this combination in the combinations is 9th, the first information in the CSI may be: 101.

In the present disclosure, after determining the first parameter, the network device first determines the number of combinations that meet the first parameter based on the first combination or the second combination that can be selected by the terminal device, then determines the bit width occupied by the first information based on the number of combinations that meet the first parameter, and then after receiving the CSI sent by the terminal device, the network device may parse the first information based on the bit width occupied by the first information, to determine the first combination or the second combination selected by the terminal device, and further determine the number of SD basis vectors selected by the terminal device corresponding to the one or more CSI-RS resources. In such way, it is ensured that the network device and the terminal device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

Referring to FIG. 10, FIG. 10 is a schematic structural diagram of a communication apparatus 1000 according to an embodiment of the present disclosure. The communication apparatus 1000 shown in FIG. 10 may include a transceiving module 1001 and a processing module 1002. The transceiving module 1001 may include a sending module and/or a receiving module, the sending module is configured to implement a sending function, the receiving module is configured to implement a receiving function, and the transceiving module 1001 may implement the sending function and/or the receiving function.

It may be understood that the communication apparatus 1000 may be a terminal device, an apparatus in a terminal device, or an apparatus that can be matched with a terminal device for use.

The communication apparatus 1000 is on a terminal device side.

The processing module 1002 is configured to determine, according to a first parameter, a bit width occupied by first information in channel state information (CSI), where the first information indicates a number of space domain (SD) basis vectors corresponding to one or more channel state information-reference signal (CSI-RS) resources selected by a terminal device. The processing module 1002 may be any type of general or specialized processor, CPU, processing device, computer, or etc.

Optionally, the first parameter includes at least one of: a maximum selectable number L of SD basis vectors corresponding to each of the CSI-RS resources; a maximum value Lₘₐₓ of a sum of a number of SD basis vectors selectable by the terminal device corresponding to all CSI-RS resources; a sum Lₜₒₜ of a number of SD basis vectors selectable by the terminal device corresponding to all CSI-RS resources; a maximum number X of first combinations, where a value of an i-th element in each of the first combinations represents a number of SD basis vectors selected by the terminal device corresponding to an i-th CSI-RS resource in all CSI-RS resources, where i is a natural number; a maximum number Y of second combinations, where a value of a j-th element in each of the second combinations represents a number of SD basis vectors selected by the terminal device corresponding to a j-th CSI-RS resource in CSI-RS resources other than a first CSI-RS resource, where j is a natural number; a number L′ of SD basis vectors corresponding to the first CSI-RS resource; a sum Lₜₒₜ′ of SD basis vectors selectable by the terminal device corresponding to CSI-RS resources other than the first CSI-RS resource; or a maximum value Lₘₐₓ′ of the sum of a number of SD basis vectors selectable by the terminal device corresponding to CSI-RS resources other than the first CSI-RS resource.

Optionally, the processing module 1002 is further configured to perform: determining the first parameter according to agreement in a protocol.

The transceiving module 1001 is further configured to perform: receiving the first parameter sent by a network device.

Optionally, the processing module 1002 is further configured to perform: when the first parameter is any one of L, Lₘₐₓ, Lₜₒₜ, Lₘₐₓ′, Lₜₒₜ′, X and Y, determining, based on

$$⌈ {log}_{2}^{T} ⌉ ,$$

a bit width occupied by first information in the CSI, where T represents the first parameter.

Optionally, the processing module 1002 is further configured to perform: when the first parameter includes Lₘₐₓ and L′, determining the bit width occupied by the first information in the CSI based on

$$⌈ {log}_{2}^{{L}_{max} - {L}^{′}} ⌉ ;$$

or when the first parameter includes Lₜₒₜ and L′, determining the bit width occupied by the first information in the CSI based on

$$⌈ {log}_{2}^{{L}_{tot} - {L}^{′}} ⌉ .$$

Optionally, the processing module 1002 is further configured to perform: when the first parameter includes any one of Lₘₐₓ, Lₜₒₜ, Lₘₐₓ′, and Lₜₒₜ′, determining a number Z of combinations that meet the first parameter according to each of the first combinations or each of the second combinations that is selectable by the terminal device; and determining the bit width occupied by the first information in the CSI based on

$$⌈ {log}_{2}^{Z} ⌉ .$$

Optionally, the processing module 1002 is further configured to perform: determining the first combinations or the second combinations according to agreement in a protocol; or the transceiving module 1001 is further configured to perform: receiving the first combinations or the second combinations sent by a network device.

Optionally, the processing module 1002 is further configured to perform: determining the first CSI-RS resource according to agreement in a protocol; or determining the first CSI-RS resource according to indication of a network device; or determining the first CSI-RS resource according to a measurement result of each of the CSI-RS resources.

Optionally, the processing module 1002 is further configured to perform: indicating the first CSI-RS resource to the network device by using second information in the CSI.

Optionally, the processing module 1002 is further configured to perform: determining a bit width occupied by the second information according to a maximum number N_{TRP} of coordinated TRPs corresponding to the terminal device.

Optionally the first information, or the second information, or both, are included in a first part (part1) of the reported CSI.

In the present disclosure, the terminal device may determine the bit width occupied by the first information in the CSI based on the first parameter in the same way as the network device does. In such way, it is ensured that the terminal device and the network device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

The communication apparatus 1000 is on a network device side.

The processing module 1002 is configured to determine, according to a first parameter, a bit width occupied by first information in channel state information (CSI) reported by a terminal device, where the first information indicates a number of space domain (SD) basis vectors selected by the terminal device corresponding to one or more channel state information-reference signal (CSI-RS) resources.

Optionally, the first parameter includes at least one of: a maximum selectable number L of SD basis vectors corresponding to each of the CSI-RS resources; a maximum value Lₘₐₓ of a sum of a number of SD basis vectors selectable by the terminal device corresponding to all CSI-RS resources; a sum Lₜₒₜ of SD basis vectors selectable by the terminal device corresponding to all CSI-RS resources; a maximum number X of first combinations, where a value of an i-th element in each of the first combinations represents a number of SD basis vectors selected by the terminal device corresponding to an i-th CSI-RS resource in all CSI-RS resources, where i is a natural number; a maximum number Y of second combinations, where a value of a j-th element in each of the second combinations represents a number of SD basis vectors selected by the terminal device corresponding to a j-th CSI-RS resource in CSI-RS resources other than a first CSI-RS resource, where j is a natural number; a number L′ of SD basis vectors corresponding to the first CSI-RS resource; a sum Lₜₒₜ′ of SD basis vectors selectable by the terminal device corresponding to CSI-RS resources other than the first CSI-RS resource; or a maximum value Lₘₐₓ′ of the sum of a number of SD basis vectors selectable by the terminal device corresponding to CSI-RS resources other than the first CSI-RS resource.

Optionally, the processing module 1002 is further configured to perform: determining the first parameter according to agreement in a protocol; or the transceiving module 1001 is further configured to configure the first parameter for the terminal device.

Optionally, the processing module 1002 is further configured to perform: when the first parameter is any one of L, Lₘₐₓ, Lₜₒₜ, Lₘₐₓ′, Lₜₒₜ′, X and Y, determining, based on

$$⌈ {log}_{2}^{T} ⌉ ,$$

a bit width occupied by first information in the CSI, where T represents the first parameter.

Optionally, the processing module 1002 is further configured to perform: when the first parameter includes Lₘₐₓ and L′, determining the bit width occupied by the first information in the CSI based on

$$⌈ {log}_{2}^{{L}_{max} - {L}^{′}} ⌉ ;$$

or when the first parameter includes Lₜₒₜ and L′, determining the bit width occupied by the first information in the CSI based on

$$⌈ {log}_{2}^{{L}_{tot} - {L}^{′}} ⌉ .$$

Optionally, the processing module 1002 is further configured to perform: when the first parameter includes any one of Lₘₐₓ, Lₜₒₜ, Lₘₐₓ′, and Lₜₒₜ′, determining a number Z of combinations that meet the first parameter according to each of the first combinations or each of the second combinations that is selectable by the terminal device; and determining the bit width occupied by the first information in the CSI based on

$$⌈ {log}_{2}^{Z} ⌉ .$$

Optionally, the processing module 1002 is further configured to perform: determining the first combinations or the second combinations according to agreement in a protocol.

The transceiving module 1001 is further configured to configure each first combination or each second combination for the terminal device.

Optionally, the processing module 1002 is further configured to perform: determining the first CSI-RS resource according to agreement in a protocol; or determining the first CSI-RS resource according to second information in the received CSI.

The transceiving module 1001 is further configured to indicate the first CSI-RS resource to the terminal device.

Optionally, the processing module 1002 is further configured to perform: determining a bit width occupied by the second information according to a maximum number N_{TRP} of coordinated TRPs corresponding to the terminal device.

Optionally the first information, or the second information, or both, are included in a first part (part1) of the reported CSI.

Optionally, the transceiving module 1001 is further configured to receive the CSI sent by the terminal device.

The processing module 1002 is further configured to determine, based on the first information in the CSI, a number of SD basis vectors corresponding to one or more CSI-RS resources selected by the terminal device.

In the present disclosure, the network device may determine the bit width occupied by the first information in the CSI based on the first parameter in the same way as the terminal device does. In such way, it is ensured that the terminal device and the network device comprehend the first information in a same way, which provides conditions for the network device to accurately determine the number of SD basis vectors selected by the terminal device corresponding to the one or more CSI-RS resources, and hence ensures that the network device can accurately calculate precoding for downlink data transmission.

It should be noted that the apparatus embodiments are obtained based on the method embodiments, and for specific descriptions, the method embodiments can be referred to, and details will not be repeated herein.

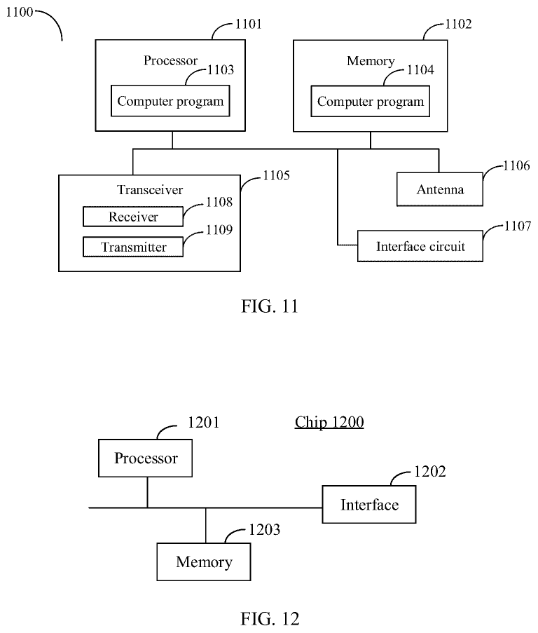

Referring to FIG. 11, FIG. 11 is a schematic structural diagram of a communication device 1100 according to an embodiment of the present disclosure. The communication device 1100 may be a network device, or a terminal device, or a chip, a chip system or a processor that supports the network device to implement the methods, or a chip, a chip system or a processor that supports the terminal device to implement the methods. The apparatus can be configured to implement the method described in the method embodiments, and specific descriptions can be referred from the method embodiments.

The communication device 1100 may include one or more processors 1101. The processor 1101 may be a general-purpose processor, a special-purpose processor, or the like. For example, the processor 1101 may be a baseband processor or a central processing unit. The baseband processor may be configured to process a communication protocol and communication data, and the central processing unit may be configured to control a communication device (for example, a base station, a baseband chip, a terminal device, a terminal device chip, a DU, or a CU), execute a computer program, and process data of the computer program.

Optionally, the communication apparatus 1100 may further include one or more memories 1102, where the one or more memories 1102 may store a computer program 1104, and the processor 1101 executes the computer program 1104, to cause the communication device 1100 to perform the method described in the method embodiments. Optionally, the memory 1102 may further store data. The communication device 1100 and the memory 1102 may be separately disposed, or may be integrated together.

Optionally, the communication device 1100 may further include a transceiver 1105 and an antenna 1106. The transceiver 1105 may be referred to as a transceiver unit, a transceiver device, a transceiver circuit, or the like, and is configured to implement a transceiving function. The transceiver 1105 may include a receiver 1108 and a transmitter 1109. The receiver 1108 may be referred to as a receiving device or a receiving circuit, and is configured to implement a receiving function. The transmitter 1109 may be referred to as a transmitting device or a transmitting circuit, and is configured to implement a transmitting function.

Optionally, the communication device 1100 may further include one or more interface circuits 1107. The interface circuits 1107 are used to receive a code instruction and transmit the code instruction to the processor 1101. The processor 1101 runs the code instruction to cause the communication device 1100 to perform the method described in the method embodiments.

In an implementation, the processor 1101 may include a transceiver configured to implement receiving and sending functions. For example, the transceiver may be a transceiver circuit, an interface, or an interface circuit. The transceiver circuit, the interface, or the interface circuit for implementing the receiving and sending functions may be separate or integrated together.

The transceiver circuit, the interface, or the interface circuit may be configured to read and write code/data, or the transceiver circuit, the interface, or the interface circuit may be configured to transmit or transmit a signal.

In an implementation, the processor 1101 can store a computer program 1103, and the computer program 1103 runs on the processor 1101, to cause the communication device 1100 to perform the method described in the method embodiments. The computer program 1103 may be solidified in the processor 1101, in which case, the processor 1101 may be implemented by hardware.

In an implementation, the communication device 1100 may include a circuit, which may realize the function of sending or receiving or communicating in the method embodiments. The processor/processing module and transceiver/transceiver module described in the present disclosure can be implemented in an integrated circuit (IC), an analog IC, a radio frequency integrated circuit (RFIC), a mixed-signal IC, an application specific integrated circuit (ASIC), a printed circuit board (PCB), an electronic device, and the like. The processor and transceiver can also be manufactured by various IC process technologies, such as complementary metal oxide semiconductor (CMOS), n-type metal oxide semiconductor (NMOS), p-type metal oxide semiconductor (PMOS), bipolar junction transistor (BJT), bipolar CMOS (BiCMOS), silicon germanium (SiGe), gallium arsenide (GaAs), etc.

The communication device described in the embodiment may be a network device or an access network device (such as the terminal device in the method embodiments), but the scope of the communication device described in the present disclosure is not limited thereto, and the structure of the communication device may not be limited by FIG. 11. The communication device may be a stand-alone device or may be a part of a larger device. For example, the communication device may be: (1) stand-alone integrated circuit (IC), or chip, or chip system or subsystem; (2) a set of one or more ICs, optionally, the IC set may also include storage components for storing data and computer programs; (3) ASIC, such as a modem; (4) a module that can be embedded in other devices; (5) a receiver, a terminal device, an intelligent terminal device, a cellular phone, a wireless device, a handset, a mobile unit, a vehicle-mounted device, a network device, a cloud device, an artificial intelligence device, etc.; or (6) others, etc.

In a case that the communication device may be a chip or a chip system, the schematic structural diagram of the chip 1200 shown in FIG. 12 can be referred to. The chip 1200 shown in FIG. 12 includes a processor 1201 and an interface 1203. There may be one or more processors 1201, and one or more interfaces 1203.

Optionally, the chip 1200 further includes a memory 1203 for storing necessary computer programs and data.

Those skilled in the art can also understand that various illustrative logical blocks and steps listed in the embodiments of the present disclosure can be implemented by electronic hardware, computer software, or a combination of both. Whether this function is implemented by hardware or software depends on the specific application and the design requirements of the whole system. Those skilled in the art can use various methods to realize the described functions for each specific application, but this realization should not be understood as beyond the scope of protection of the embodiments of the present disclosure.

The present disclosure also provides a non-transitory computer-readable storage medium, storing an instruction, where when the instruction is executed by a computer, a function of any one of the method embodiments is implemented.

The present disclosure also provides computer program product, where when the computer program product is executed by a computer, a function of any one of the method embodiments is implemented.

The embodiments can be implemented in whole or in part by software, hardware, firmware or any combination thereof. When implemented in software, the embodiments can be fully or partially implemented in a form of a computer program product. The computer program product includes one or more computer programs. When the computer program is loaded and executed on a computer, a procedure or function according to the embodiment of the present disclosure is generated in whole or in part. The computer can be a general-purpose computer, a special-purpose computer, a computer network, or other programmable devices. The computer program can be stored in a computer-readable storage medium or transmitted from one computer-readable storage medium to another. For example, the computer program can be transmitted from a website, a computer, a server or a data center to another website, a computer, a server or a data center, through a wired manner (e.g., a coaxial cable, an optical fiber, a digital subscriber line) or a wireless manner (infrared, wireless, microwave). The computer-readable storage medium may be any available medium that a computer can access, or a data storage device such as a server, a data center and the like integrated by one or more available medium. The available medium may be a magnetic medium (e.g., floppy disk, hard disk, magnetic tape), an optical medium (e.g., high-density digital video disc (DVD)), or a semiconductor medium (e.g., solid state disk (SSD)) and the like.

It can be understood that “plural” in the present disclosure refers to two or more, and other quantifiers are similar. The “and/or” describes an association relationship of associated objects, indicating that there may be three relationships, for example, A and/or B may indicate three cases: A alone, both A and B, and B alone. The character “/” generally indicates that the objects are in an “OR” relationship. The singular forms “a/an”, “the”, and “said” are also intended to include plural forms unless the context clearly indicates other meanings.

It can be further understood that although the operations are described in a specific order in the drawings in the embodiment of the present disclosure, it should not be understood as requiring that these operations be performed in the specific order or serial order shown, or that all the operations shown should be performed to obtain the desired results. In certain circumstances, multitasking and parallel processing may be beneficial.

It can be understood by those skilled in the art that the “first”, “second” and other numerical numbers involved in the present disclosure are only for the convenience of description, and are not used to limit the scope of the embodiments of the present disclosure, but also indicate the order.

The “at least one of” in the present disclosure can also be described as one or more, and “a plurality of” may be two, three, four or more, which is not limited in the present disclosure. In the embodiments of the present disclosure, for a technical feature, technical features in the technical feature are distinguished by “first”, “second”, “third”, “A”, “B”, “C” and “D”. The technical features described by “first”, “second”, “third”, “A”, “B”, “C” and “D” are not ordered in sequence or in size.

The correspondence shown in each table in the present disclosure can be configured or predefined. Values of the information in each table are only examples, and can be configured as other values, which is not limited in the present disclosure. When configuring the correspondence between information and parameters, it is not necessary to configure all the correspondence indicated in each table. For example, in the table in the present disclosure, the corresponding relationship shown by some rows may not be configured. For another example, appropriate deformation adjustments can be made based on the table, such as splitting, merging and so on. The names of the parameters indicated by the headings in the tables can also be other names that can be understood by the communication device, and the values or representations of the parameters can also be other values or representations that can be understood by the communication device. Other data structures can also be used when the tables are implemented, such as arrays, queues, containers, stacks, linear tables, pointers, linked lists, trees, graphs, structures, classes, heaps, Hash tables, etc.

Pre-definition in the present disclosure can be understood as definition, definition in advance, storage, pre-storage, pre-negotiation, pre-configuration, solidifying, or pre-firing.

Those skilled in the art may notice that the units and algorithm steps of various examples described in connection with the embodiments disclosed herein can be implemented in electronic hardware, or a combination of computer software and electronic hardware. Whether these functions are implemented in hardware or software depends on the specific application and design constraints of the technical solution. Those skilled in the art can use different manners to implement the described functions for each specific application, but such implementation should not be considered beyond the scope of the present disclosure.

It can be clearly understood by those skilled in the art that for the convenience and conciseness of description, the specific working processes of the systems, devices and units described can refer to the corresponding processes in the method embodiments, and will not be repeated herein.

Other embodiments of the present disclosure will easily occur to those skilled in the art after considering the specification and practicing the present disclosure herein. The present application is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

The above is only the specific implementation of the present disclosure, but the protection scope of the present disclosure is not limited thereto. Any person familiar with the technical field can easily think of changes or substitutions within the technical scope disclosed in the present disclosure, which should be included in the protection scope of the present disclosure. Therefore, the protection scope of the present disclosure should be based on the protection scope of the claims.

1. A method for determining channel state information (CSI), performed by a terminal device, comprising:
determining, according to a first parameter, a bit width occupied by first information in the CSI, wherein the first information indicates a number of space domain (SD) basis vectors selected by the terminal device corresponding to one or more channel state information-reference signal (CSI-RS) resources.

2. The method according to claim 1, wherein the first parameter comprises at least one of:
a maximum selectable number L of SD basis vectors corresponding to each of the CSI-RS resources;
a maximum value Lₘₐₓ of a sum of a number of SD basis vectors selectable by the terminal device corresponding to all CSI-RS resources;
a sum Lₜₒₜ of a number of SD basis vectors selectable by the terminal device corresponding to all CSI-RS resources;
a maximum number X of first combinations, wherein a value of an i-th element in each of the first combinations represents a number of SD basis vectors selected by the terminal device corresponding to an i-th CSI-RS resource in all CSI-RS resources, wherein i is a natural number;
a maximum number Y of second combinations, wherein a value of a j-th element in each of the second combinations represents a number of SD basis vectors selected by the terminal device corresponding to a j-th CSI-RS resource in CSI-RS resources other than a first CSI-RS resource, wherein j is a natural number;
a number L′ of SD basis vectors corresponding to the first CSI-RS resource;
a sum Lₜₒₜ′ of a number of SD basis vectors selectable by the terminal device corresponding to CSI-RS resources other than the first CSI-RS resource; or
a maximum value Lₘₐₓ′ of the sum of a number of SD basis vectors selectable by the terminal device corresponding to CSI-RS resources other than the first CSI-RS resource.

3. The method according to claim 2, further comprising:
determining the first parameter according to agreement in a protocol; or
receiving the first parameter sent by a network device.

4. The method according to claim 2, wherein determining, according to the first parameter, the bit width occupied by the first information in the CSI comprises:
determining the bit width occupied by the first information in the CSI based on
$$⌈ {log}_{2}^{T} ⌉$$
when the first parameter comprises any one of: L, Lₘₐₓ, Lₜₒₜ, Lₘₐₓ′, Lₜₒₜ′, X and Y, wherein T represents the first parameter.

5. The method according to claim 2, wherein determining, according to the first parameter, the bit width occupied by the first information in the CSI comprises:
when the first parameter comprises Lₘₐₓ and L′, determining the bit width occupied by the first information in the CSI based on
$$⌈ {log}_{2}^{{L}_{max} - {L}^{′}} ⌉ ;$$
or
when the first parameter comprises Lₜₒₜ and L′, determining the bit width occupied by the first information in the CSI based on
$$⌈ {log}_{2}^{{L}_{tot} - {L}^{′}} ⌉ .$$

6. The method according to claim 2, wherein determining, according to the first parameter, the bit width occupied by the first information in the CSI comprises:
when the first parameter comprises any one of Lₘₐₓ, Lₜₒₜ, Lₘₐₓ′ and Lₜₒₜ′, determining a number Z of combinations that meet the first parameter according to each of the first combinations or each of the second combinations that is selectable by the terminal device; and
determining the bit width occupied by the first information in the CSI based on
$$⌈ {log}_{2}^{Z} ⌉ .$$

7. The method according to claim 2, further comprising:
determining the first combinations or the second combinations according to agreement in a protocol; or
receiving the first combinations or the second combinations sent by a network device.

8. The method according to claim 2, further comprising:
determining the first CSI-RS resource according to agreement in a protocol; or
determining the first CSI-RS resource according to indication of a network device; or
determining the first CSI-RS resource according to a measurement result of each of the CSI-RS resources,
wherein the method further comprises:
indicating the first CSI-RS resource to the network device by using second information in the CSI;
wherein the method further comprises:
determining a bit width occupied by the second information according to a maximum number N_{TRP} of coordinated TRPs corresponding to the terminal device, and
wherein the first information, or the second information, or both, are comprised in a first part (part1) of the reported CSI.

9.-11. (canceled)

12. A method for determining channel state information (CSI), performed by a network device, comprising:
determining, according to a first parameter, a bit width occupied by first information in the CSI reported by a terminal device, wherein the first information indicates a number of space domain (SD) basis vectors selected by the terminal device corresponding to one or more channel state information-reference signal (CSI-RS) resources.

13. The method according to claim 12, wherein the first parameter comprises at least one of:
a maximum selectable number L of SD basis vectors corresponding to each of the CSI-RS resources;
a maximum value Lₘₐₓ of a sum of a number of SD basis vectors selectable by the terminal device corresponding to all CSI-RS resources;
a sum Lₜₒₜ of a number of SD basis vectors selectable by the terminal device corresponding to all CSI-RS resources;
a maximum number X of first combinations, wherein a value of an i-th element in each of the first combinations represents a number of SD basis vectors selected by the terminal device corresponding to an i-th CSI-RS resource in all CSI-RS resources, wherein i is a natural number;
a maximum number Y of second combinations, wherein a value of a j-th element in each of the second combinations represents a number of SD basis vectors selected by the terminal device corresponding to a j-th CSI-RS resource in CSI-RS resources other than a first CSI-RS resource, wherein j is a natural number;
a number L′ of SD basis vectors corresponding to the first CSI-RS resource;
a sum Lₜₒₜ′ of a number of SD basis vectors selectable by the terminal device corresponding to CSI-RS resources other than the first CSI-RS resource; or
a maximum value Lₘₐₓ′ of the sum of a number of SD basis vectors selectable by the terminal device corresponding to CSI-RS resources other than the first CSI-RS resource.

14. The method according to claim 13, further comprising at least one of:
determining the first parameter according to agreement in a protocol; or
configuring the first parameter for the terminal device.

15. The method according to claim 13, wherein determining, according to the first parameter, the bit width occupied by the first information in the CSI reported by the terminal device comprises:
determining the bit width occupied by the first information in the CSI based on
$$⌈ {log}_{2}^{T} ⌉$$
when the first parameter comprises any one of: L, Lₘₐₓ, Lₜₒₜ, Lₘₐₓ′, Lₜₒₜ′, X and Y, wherein T represents the first parameter.

16. The method according to claim 13, wherein determining, according to the first parameter, the bit width occupied by the first information in the CSI reported by the terminal device comprises:
when the first parameter comprises Lₘₐₓ and L′, determining the bit width occupied by the first information in the CSI based on
$$⌈ {log}_{2}^{{L}_{max} - {L}^{′}} ⌉ ;$$
or
when the first parameter comprises Lₜₒₜ and L′, determining the bit width occupied by the first information in the CSI based on
$$⌈ {log}_{2}^{{L}_{tot} - {L}^{′}} ⌉ .$$

17. The method according to claim 13, wherein determining, according to the first parameter, the bit width occupied by the first information in the CSI reported by the terminal device comprises:
when the first parameter comprises any one of Lₘₐₓ, Lₜₒₜ, Lₘₐₓ′ and Lₜₒₜ′, determining a number Z of combinations that meet the first parameter according to each of the first combinations or each of the second combinations that is selectable by the terminal device; and
determining the bit width occupied by the first information in the CSI based on
$$⌈ {log}_{2}^{Z} ⌉ .$$

18. The method according to claim 13, further comprising at least one of:
determining the first combinations or the second combinations according to agreement in a protocol; or
configuring the first combinations or the second combinations for the terminal device.

19. The method according to claim 13, further comprising:
determining the first CSI-RS resource according to agreement in a protocol; or
indicating the first CSI-RS resource to the terminal device; or
determining the first CSI-RS resource according to second information in the received CSI,
wherein the method further comprises:
determining a bit width occupied by the second information according to a maximum number N_{TRP} of coordinated TRPs corresponding to the terminal device, and
wherein the first information, or the second information, or both, are comprised in a first part (part1) of the reported CSI.

20.-21. (canceled)

22. The method according to claim 12, further comprising:
receiving the CSI sent by the terminal device; and
determining, according to the first information in the CSI, the number of SD basis vectors selected by the terminal device corresponding to the one or more CSI-RS resources.

23.-24. (canceled)

25. A communication device comprising:
a processor; and
a memory storing a computer program, and
wherein the processor executes the computer program stored in the memory, to cause the device to implement the method according to claim 1.

26. A communication system, comprising
a terminal device; and
a network device, and
wherein the terminal device is configured to:
determine, according to a first parameter, a bit width occupied by first information in channel state information (CSI), wherein the first information indicates a number of space domain (SD) basis vectors selected by the terminal device corresponding to one or more channel state information-reference signal (CSI-RS) resources, and
wherein the network device is configured to perform the method according to claim 12.

27. A non-transitory computer-readable storage medium, storing an instruction, wherein when the instruction is executed, the method according to claim 1 is implemented.
